(19) United States
(12) Patent Application Publication
(10) Pub. No.: US 2025/0156219 A1
(43) Pub. Date: May 15, 2025

(54) COMPUTER SYSTEM AND METHOD FOR APPLICATION COMPATIBLE EXECUTION

(71) Applicant: Shanghai Zhaoxin Semiconductor Co., Ltd., Shanghai (CN)

(72) Inventors: Weilin WANG, Beijing (CN); Yingbing GUAN, Shanghai (CN)

(21) Appl. No.: 18/630,090

(22) Filed: Apr. 9, 2024

(30) Foreign Application Priority Data
Nov. 10, 2023 (CN) 202311503488.5

(51) Int. Cl. G06F 9/48; G06F 9/30; G06F 9/4401; G06F 9/50

(52) U.S. Cl. CPC G06F 9/4856; G06F 9/30145; G06F 9/4405; G06F 9/4881; G06F 9/5027; G06F 2209/481

(57) ABSTRACT

A computer system with a hybrid architecture processor that provides both first-type and second-type cores is shown. The second-type core uses special instructions not supported by the first-type core, or supported by the first-type core in a semantically changed manner. In response to the first-type core executing an application that has any of the special instructions, the application is migrated to the second-type core for execution.

### CROSS REFERENCE TO RELATED APPLICATIONS

This application claims priority of China Patent Application No. 202311503488.5, filed on Nov. 10, 2023, the entirety of which is incorporated by reference herein.

### BACKGROUND OF THE DISCLOSURE

### Field of the Disclosure

The present disclosure relates to a hybrid architecture processor of a computer system, and in particular to application compatibility on a hybrid architecture processor.

### Description of the Related Art

With the booming development of computing technology, hybrid architecture processors have been proposed as a means of balancing between performance and power consumption. A hybrid architecture processor contains at least two types of cores, and each type of core may support different instructions (for example, one type of core may support a complete set of instructions, while another type of core may support partial instructions). Thus, it is hard to schedule an application process on a hybrid architecture processor. In order to reduce the difficulty of application process scheduling, the existing technology may downgrade the bigger core, which supports more instructions, to a smaller core, to use only a part of the instructions of the bigger core. This is a waste of computing resources. How to fully utilize the resources of each core in a hybrid architecture processor is one of the problems to be solved by those skilled in the art.

### BRIEF SUMMARY OF THE DISCLOSURE

This case proposes a computer system and a method for application compatible execution.

A computer system in accordance with an exemplary embodiment of the disclosure includes a hybrid architecture processor that includes a first-type core and a second-type core. The second-type core uses special instructions not supported by the first-type core, or supported by the first-type core in a semantically changed manner. In response to the first-type core executing an application that has any of the special instructions, the application is migrated to the second-type core for execution.

In another exemplary embodiment, a method for application compatible execution is shown, which includes the following steps: providing a hybrid architecture processor that includes a first-type core and a second-type core, wherein the second-type core uses special instructions not supported by the first-type core, or supported by the first-type core in a semantically changed manner; and in response to the first-type core executing an application that has any of the special instructions, migrating the application to the second-type core for execution.

Through the computer system and the method proposed in this paper, when the first-type core executes a special instruction that is not supported or has changed semantics on the first-type core, the application is scheduled to run on the second-type core to fully utilize the resources of the second-type core.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 illustrates a computer system 100 in accordance with an exemplary embodiment of the disclosure, which includes a hybrid architecture processor 102 and a system memory 104 coupled to the hybrid architecture processor 102;

FIG. 2 illustrates a core 200 in accordance with an exemplary embodiment of the disclosure;

FIG. 3 is a flow chart, illustrating how the BIOS 112 collects the core information of each core (identification code that distinguishes the first-type core 106_# from the second type core 108_#) in accordance with an exemplary embodiment, for later use in the operating system;

FIG. 4A illustrates a processor local APIC structure 400 that is proposed to build a multiple APIC description table, which includes a flag field 401;

FIG. 4B illustrates the details of the flag field 402, which includes an enable bit, reserved bits, and an identification code bit 404; and

FIGS. 5A and 5B are flow charts illustrating the operations of the operating system in accordance with an exemplary embodiment of the disclosure.

### DETAILED DESCRIPTION OF THE DISCLOSURE

The following description enumerates various embodiments of the disclosure, but is not intended to be limited thereto. The actual scope of the disclosure should be defined according to the claims. The various blocks/modules mentioned below may be implemented by a combination of hardware, software, and firmware, and may also be implemented by special circuits. The various blocks/modules are not limited to being implemented separately, but can also be combined together to share certain functions. In this paper, the descriptions “execute (or run) an application process” and “execute (or run) an application” have the same meaning.

With the development of technology, processors may be improved from legacy architecture to new generation architecture. The hardware design of the new generation architecture may be simpler than that of the legacy architecture. For example, the legacy 32-bit computing is no longer supported in the new generation architecture. The new generation architecture may only support 64-bit computing.

In the generation evolution, most applications on the market are still designed for the legacy architecture, and are hereinafter referred to as legacy applications. Legacy applications may use legacy instructions that the new generation architecture cannot handle. The solution proposed in this disclosure is to design a hybrid architecture processor that does not only provide a new generation core, but also provides a legacy core to cope with legacy applications.

In another exemplary embodiment, a hybrid architecture processor uses a simplified architecture core and a legacy core, wherein the legacy core is provided to cope with legacy applications. In such an exemplary embodiment, the simplified architecture core may be called a small core, and the legacy core may be called a big core.

In an exemplary embodiment, the hybrid architecture processor in this disclosure includes a first-type core and a second-type core. In an exemplary embodiment, the first-type core may be a new generation core and the second-type core may be a legacy core. Alternatively, the first-type core may be a small core and the second-type core may be a big core. The following description about the first-type core and the second-type core uses the new generation core and the legacy core as examples, but it also works on examples using small core and big core. Any processor including several types of cores (which support different instruction sets) may be used to implement the hybrid architecture processor in this disclosure.

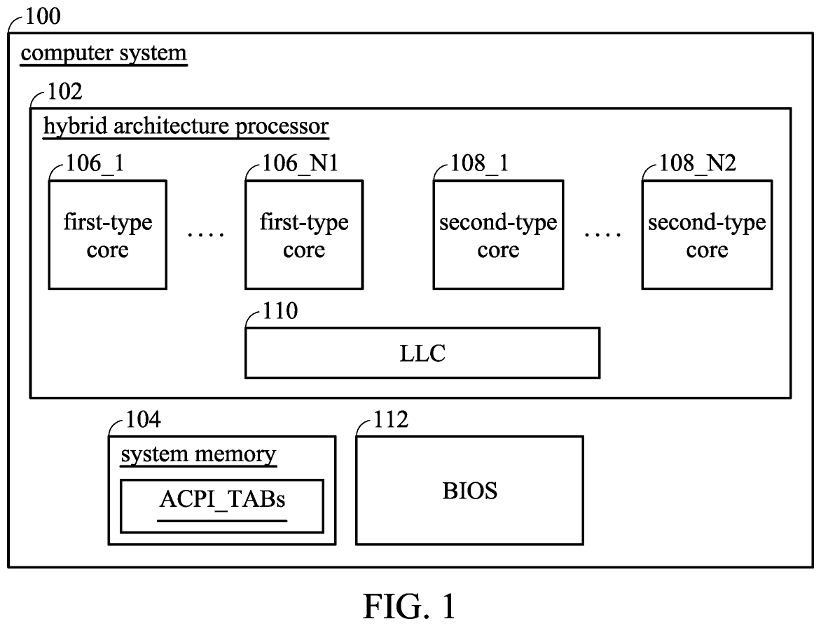

FIG. 1 illustrates a computer system 100 in accordance with an exemplary embodiment of the disclosure, which includes a hybrid architecture processor 102 and a system memory 104 coupled to the hybrid architecture processor 102. The hybrid architecture processor 102 includes at least one first-type core (106_1 . . . 106_N1, hereinafter referred to as 106_#), and at least one second-type core (108_1 . . . 108_N2, hereinafter referred to as 108_#). The hybrid architecture processor 102 further includes a last level cache (LLC) 110, which is shared by the cores 106_1 . . . 106_N1 and 108_1 . . . 108_N2. In an exemplary embodiment, the cores 106_1 . . . 106_N1 and 108_1 . . . 108_N2 each is a logical core.

The hardware of the first-type core 106_# may be simpler (or more advanced) than that of the second-type core 108_#. In an exemplary embodiment, the first-type core 106_# only supports 64-bit operations, and the 32-bit operations supported by second-type core 108_# are not supported by the first-type core 106_#. Special instructions are monitored in the disclosure. Some special instructions are supported by the second-type core 108, but are not supported by the first-type core 106. Some special instructions supported by the second-type core 108_# are supported by the first-type core 106_# in a semantically changed manner.

In such a hybrid architecture processor 102, the operating system must assign the appropriate applications to the first-type core 106_# and the second-type core 108_#. For example, the operating system may schedule the first-type core 106_# to run 64-bit applications, and schedule the second-type core 108_# to run legacy applications. A legacy application assigned to the first-type core 106_# may result in exceptions. In response to such exceptions, the operating system may schedule the second-type core 108_# to run the legacy application.

The following shows how to change from the first-type core 106_# to the second-type core 108_# to adaptive to the target application. After being powered on or reset, the computer system 100 runs a basic input output system (BIOS) 112 to create an Advanced Configuration and Power Interface table (ACPI table) for each core. In the ACPI table, one bit (a reserved bit or a newly added bit) is allocated for identification of the first-type core 106_# and the second-type core 108_#. The BIOS 112 may store the ACPI tables into the system memory 104 (ACPI_TABs in the figure). Based on the information obtained from the ACPI tables ACPI_TABs, the operating system switches to the proper core to execute the target application.

Other implementations may not be limited to using an ACPI table to record the core type of each core. The BIOS 112 may use any data structure that the operating system can recognize to record the core type of each core.

The aforementioned special instructions may be classified into two kinds. The first kind of special instructions are supported by the second-type core 108_#, but not supported by the first-type core 106_# (i.e., undefined in the first-type core 106_#). The second kind of special instructions are supported by the first-type cores 106_# as well as the second-type cores 108_# in a semantically changed manner. When being executed by the first-type core 106_#, the first kind of special instructions may cause an undefined instruction exception #UD, and the second kind of special instructions may cause a general-purpose exception #GP.

However, except for the first kind of special instructions only defined in the second-type core 108_#, some other instructions not defined in both the first-type core 106_# and the second-type core 108_# may also cause the undefined instruction exception #UD. In an exemplary embodiment, an undefined instruction exception handler (#UD exception handler) is proposed, to determine whether the undefined instruction exception #UD is caused by the first kind of special instructions or not. If yes, the undefined instruction exception handler performs core change adaptive to the first kind of special instructions. Such an undefined instruction exception handler is the first exception handler.

Similarly, except for the second kind of special instructions (semantically changed instructions), the first-type core 106_# may have other semantic protection designs that will cause the general-purpose exception #GP. In an exemplary embodiment, a general-purpose exception handler (#GP exception handler) is proposed, to determine whether the general-purpose exception #GP is caused by the second kind of special instruction or not. If yes, the general-purpose exception handler performs core change adaptive to the second kind of special instructions. Such a general-purpose exception handler is the second exception handler.

In an exemplary embodiment, the undefined instruction exception handler executed in response to an undefined instruction exception #UD looks up a table to identify the exception #UD and, based on the identified result, the undefined instruction exception handler decides whether to schedule the second-type core 108_# to run the target application. For example, the undefined instruction exception handler may use a special instruction table to list the opcodes used in the first kind of special instructions (supported by the second-type core 108_# but not supported by the first-type core 106_#). If any opcode of a target instruction causing the undefined instruction exception #UD is listed in the special instruction table (hit), the undefined instruction exception handler determines that the target instruction is designed to be executed by the second-type core 108_# rather than by the first-type core 106_#.

In an exemplary embodiment, the general-purpose exception handler executed in response to a general-purpose exception #GP looks up a table to identify the exception #GP and, based on the identified result, the general-purpose exception handler decides whether to schedule the second-type core 108_# to run the target application. For example, the general-purpose exception handler may use a special instruction table to list the opcodes used in the second kind of special instructions (with changed semantics in the first-type core 106_#). If any opcode of a target instruction causing the general-purpose exception #GP is listed in the special instruction table (hit), the general-purpose exception handler further checks an error code of the general-purpose exception #GP, to determine whether the target instruction is more suitable to the second-type core 108_#. In another exemplary embodiment, when determining that the target instruction causing the general-purpose exception #GP has any opcode listed in the special instruction table (hit), the general-purpose exception handler further checks the error code of the general-purpose exception #GP and a source operand (src) of the target instruction, to determine whether the target instruction is more suitable to the second-type core 108_#.

The following uses I/O instruction (i.e., IN or OUT instruction) as an example to explain in detail how to determine whether a target instruction causing the general-purpose exception #GP is one of the special instructions defined in the disclosure. When the first-type core 106_# executing I/O instruction results in a general-purpose exception #GP, the error code of the general-purpose exception #GP is pushed into a stack, and a general-purpose exception handler is triggered. According to the general-purpose exception handler, the error code of the general-purpose exception #GP is read from the stack to determine whether the error code is a predetermined value (for example, 0). If the error code of the general-purpose exception #GP is not the predetermined value, it means that the I/O instruction is not a special instruction monitored in the disclosure. If the error code of the general-purpose exception #GP is the predetermined value, it is further checked whether the opcode of the I/O instruction is listed in the special instruction table. If not (miss), it means that the I/O instruction is not a special instruction monitored in the disclosure. If the opcode of the I/O instruction is listed in the special instruction table (hit), it means that the I/O instruction is a special instruction monitored in the disclosure.

The following uses jump instructions (such as JMP, JE, JNE, JZ, JNZ, etc.) as an example to explain in detail how to determine whether a target instruction causing the general-purpose exception #GP is a special instruction monitored in the disclosure. When the first-type core 106_# executing a jump instruction results in a general-purpose exception #GP, the error code of the general-purpose exception #GP is pushed into a stack, and a general-purpose exception handler is triggered. According to the general-purpose exception handler, it is checked whether the opcode of the jump instruction is listed in the special instruction table. If not (miss), it means that the jump instruction is not the special instruction monitored in the disclosure. If the opcode of the jump instruction is listed in the special instruction table (hit), the general-purpose exception handler reads the error code of the general-purpose exception #GP from the stack, uses the source operand of the jump instruction as a base address, and uses the error code of the general-purpose exception #GP as a segment selector. Accordingly, a segment descriptor table is searched for a matched segment descriptor. If no matched content exists in the segment descriptor table, it means that the jump instruction is a special instruction suitable to the second-type core 108_#. If a matched segment descriptor is obtained, based on the properties of the obtained segment descriptor, it is determined whether the obtained segment descriptor is supported by the first-type core 106_#. If yes, it means that the jump instruction is not a special instruction suitable for execution on the second-type core 108_#. If no, it means that this jump instruction is a special instruction suitable for execution on the second-type core 108_#. In an exemplary embodiment, the first-type core 106_# only supports 64-bit segment descriptors. When the obtained segment descriptor is a 16-bit or 32-bit descriptor, it is determined that the obtained segment descriptor is not suitable for execution on the first-type core 106_#, and should be assigned to the second-type core 108_#. In an exemplary embodiment, the source operand of the target instruction is stored in the stack before the execution of the general-purpose exception handler. The source operand of the target instruction is retrieved from the stack when the general-purpose exception handler operates.

In an exemplary embodiment, each general-purpose exception #GP is represented by an exception code, and the exception code is pushed into the stack. Based on the stacked exception code, the general-purpose exception handler, executed in response to the general-purpose exception #GP, determines whether the target instruction causing the general-purpose exception #GP is a special instruction suitable for execution on the second-type core 108_#. In an exemplary embodiment, when the exception code of the general-purpose exception #GP is a specific value other than 0 (for example, 50 or 51), it means that the target instruction causing the general-purpose exception #GP is a special instruction suitable for execution on the second-type core 108_#.

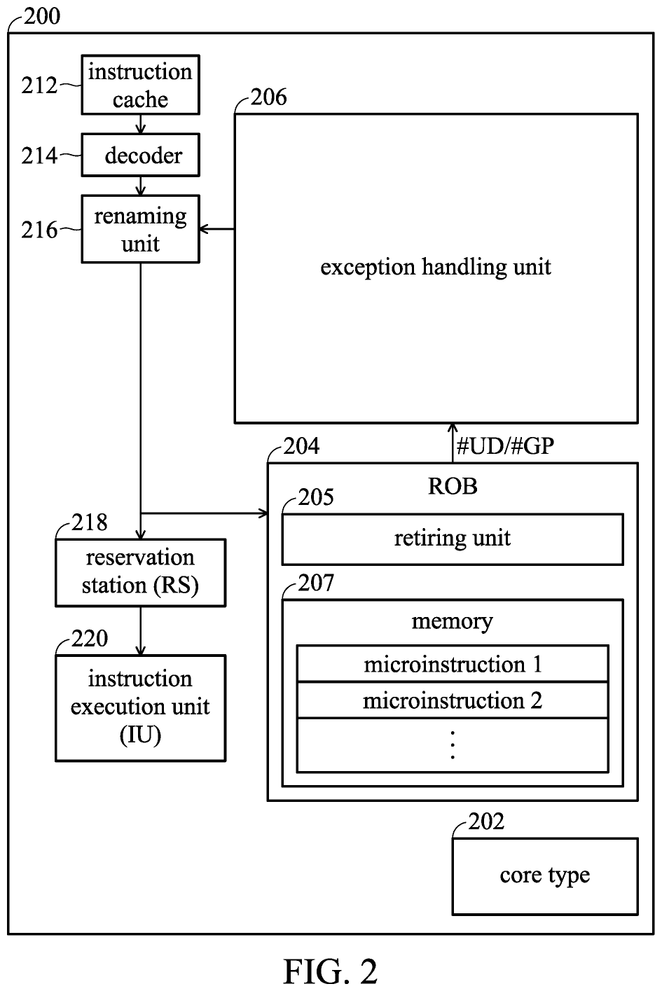

FIG. 2 illustrates a core 200 in accordance with an exemplary embodiment of the disclosure.

To be used in the proposed hybrid architecture processor, the core 200 may use a model-specific register (MSR) 202 to mark itself as a first-type core 106_# or a second-type core 108_#. The MSR 202 may store an identification code to show the core type; for example, “1” represents that this core 200 is a first-type core 106_#, and “0” represents that this core 200 is a second-type core 108_#.

This paragraph takes the first-type core 106_# as an example. The first-type core 106_# executes an application. If an undefined instruction exception #UD or a general-purpose exception #GP occurs and is buffered in the reorder buffer (ROB) 204, according to the microcode (ucode), an exception handling unit 206 calls the corresponding exception handler that is managed in an interrupt descriptor table (stored in the system memory). According to the exception handler, it is determined whether the target instruction causing the undefined instruction exception #UD or the general-purpose exception #GP is a special instruction monitored in the disclosure. In response to the identified special instruction, the operating system schedules the second-type core 108_# to run the target application. The exception handlers are registered in the interrupt descriptor table by the operating system.

The operating system migrates an application from the first-type core 106_# to the second-type core 108_# by: relating the application to the second-type core 108_# (e.g., by asserting a setting bit); and, scheduling the second-type core 108_# to take over running the application.

This paragraph details operations of the core 200. An instruction cache 212 caches instructions retrieved from the system memory 104. The decoder 214 decodes the instructions obtained from the instruction cache 212 (which are macro instructions), to generate microinstruction(s). For example, each macro instruction may be decoded to at least one microinstruction. In the illustrated example, a macro instruction is decoded to microinstructions 1 and 2, which are renamed by a renaming unit 216 (e.g., assigning the microinstructions to physical registers) and sent to a reservation station (RS) 218 as well as the reorder buffer 204 in their program order. The reservation station (RS) 218 receives and saves the microinstructions from the renaming unit 216. When the microinstructions meet the execution conditions, the microinstructions are sent to an instruction execution unit 220 (wherein the microinstructions sent to the instruction execution unit 220 may not follow their program order). The instruction execution unit 220 executes the microinstruction received from the reservation station 218, writes the execution results (including normal execution results and abnormal results) into the entries, corresponding to the microinstructions, in a memory 207, and marks them as completed execution. The reorder buffer 204 writes the microinstructions received from the renaming unit 216 into the memory 207 in their program order. A retiring unit 205 determines whether the oldest microinstruction in the memory 207 (the oldest unretired microinstruction in program order) satisfies the retiring condition. If yes, the oldest microinstruction is retired. If the target to be retired is irrelevant to any exception, the retiring is performed in a normal manner (such as updating the architectural registers, deleting the corresponding microinstruction from the memory 207, etc.). As for a retiring target with an exception, the related message (including information of the exception) is sent to the exception handling unit 206. Based on the received message, the exception handling unit 206 determines the exception type about the retiring target and, accordingly, searches the interrupt descriptor table (stored in the system memory) to run the corresponding exception handler (#UD handler or #GP handler).

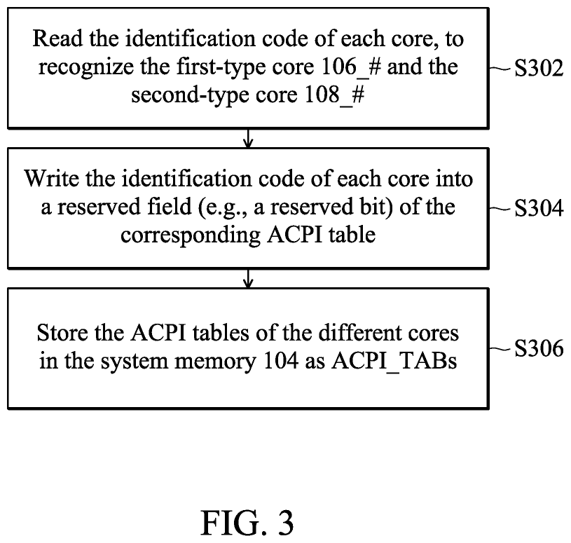

FIG. 3 is a flow chart, illustrating how the BIOS 112 collects the core information of each core (identification code that distinguishes the first-type core 106_# from the second type core 108_#) in accordance with an exemplary embodiment, for later use in the operating system.

In step S302, the BIOS 112 reads the identification code (e.g., a numerical code “arch”) of each core, to recognize the first-type core 106_# and the second-type core 108_#. In an exemplary embodiment, the BIOS 112 reads the identification code of each core to recognize the first-type core 106_# and the second-type core 108_# after the computer system 100 is powered on or reset. In an exemplary embodiment, the BIOS 112 reads the MSR (referring to 202 of FIG. 2) of each core to obtain the identification code. In another exemplary embodiment, the BIOS 112 obtains the identification code of each core by executing an acquiring identification code instruction (CPUID) on each core. In step S304, the BIOS 112 writes the identification code of each core into a reserved field (e.g., a reserved bit) of the corresponding ACPI table, and then stores the ACPI tables of the different cores in the system memory 104 as ACPI_TABs (step S306). The BIOS 112 is not limited to recording the identification code of each core in the ACPI tables. In other exemplary embodiments, the BIOS 112 defines another table for each core to record the identification code.

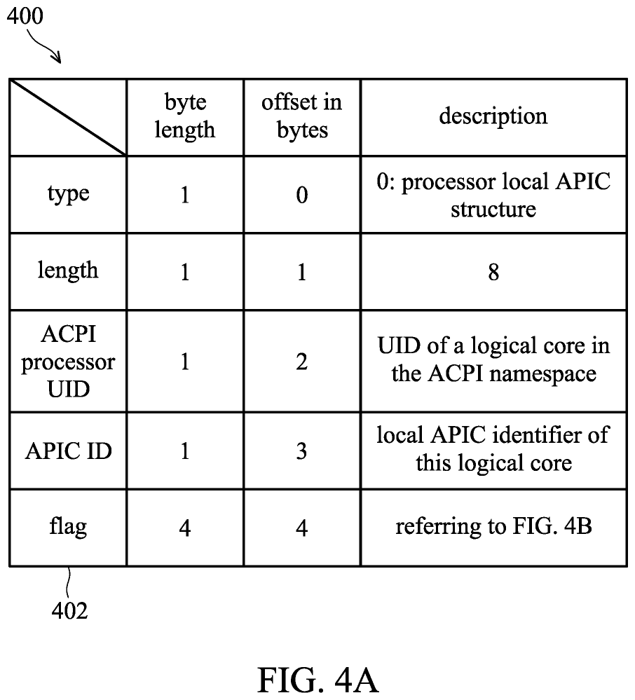

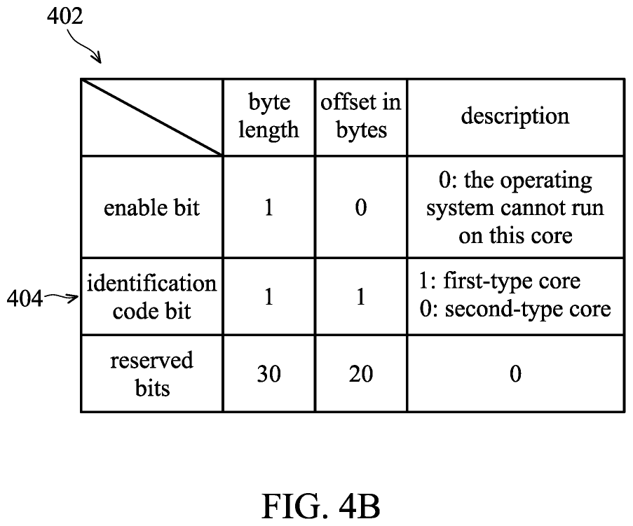

FIG. 4A illustrates a processor local APIC structure 400 that is proposed to build a multiple APIC description table (MADT, wherein APIC is the abbreviation of advanced programmable interrupt controller). The processor local APIC structure 400 is formed by several fields, to record information about: type, length, ACPI processor UID, APIC ID, and flag (field 402). The type field shows the type of information stored in the structure 400; for example, “0” represents the processor local APIC structure. The length field indicates the length of structure 400; for example, “8” indicates that the length of the structure 400 is 8 bytes. The ACPI processor UID field indicates the UID (Unique identifier) of this logical core in the ACPI namespace. The APIC ID field indicates the local APIC identifier of this logical core. The flag field 402 is described in detail below with reference to FIG. 4B.

FIG. 4B illustrates the details of the flag field 402, which includes an enable bit, reserved bits, and an identification code bit 404. The enable bit indicates whether the operating system is allowed to use this core. In an exemplary embodiment, if the enable bit is 0, it indicates that the operating system cannot run on this core; and if the enable bit is 1, it indicates that the operating system can run on this core. The reserved bits are reserved for the other design. The identification code bit 404 shows the type of the corresponding core (for example, the first-type core 106_# or the second-type core 108_#). In an exemplary embodiment, if the identification code bit is 1, it indicates that the corresponding core is the first-type core 106_#; and if the identification code bit is 0, it indicates that the corresponding core is the second-type core 108_#.

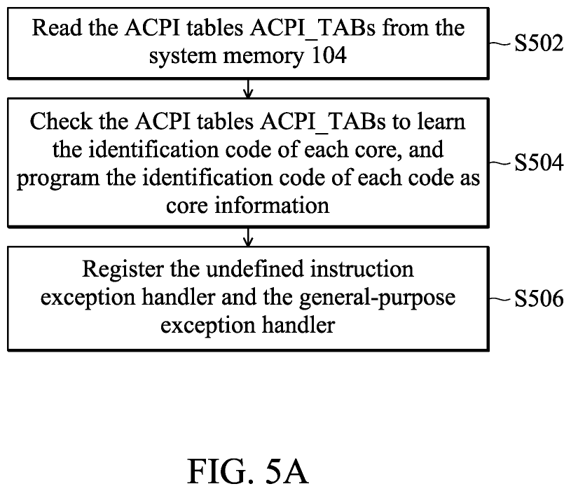

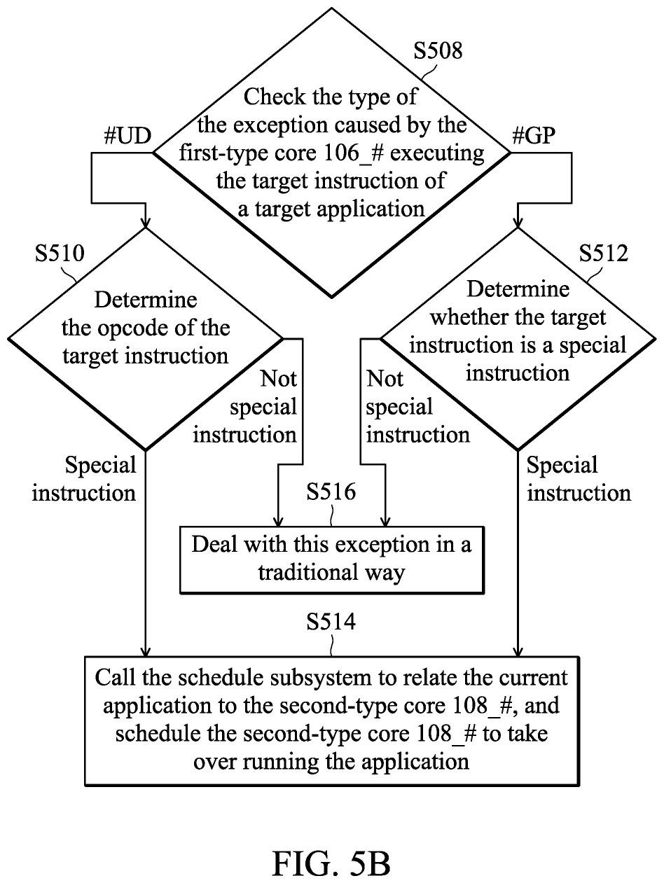

FIGS. 5A and 5B are flow charts illustrating the operations of the operating system in accordance with an exemplary embodiment of the disclosure.

As shown in FIG. 5A, when the computer system 100 starts the operating system, step S502 is executed. In step S502, the computer system 100 reads the ACPI tables ACPI_TABs from the system memory 104. In step S504, the computer system 100 checks the ACPI tables ACPI_TABs to learn the identification code of each core, and programs the identification code of each code to a processor information structure (cpuinfo) of each core. The processor information structure (cpuinfo) is defined by the operating system to record the core information of each core. As mentioned above, the type of each core can be recognized according to the identification code (indicating a first-type core 106_# or a second-type core 108_#). In step S506, an undefined instruction exception handler and a general-purpose exception handler are registered. In an exemplary embodiment, the undefined instruction exception handler and the general-purpose exception handler are two new branches added to the exception handling functions of the core. The undefined instruction exception handlers and general-purpose exception handlers are registered in the interrupt descriptor table by the operating system. When the retiring unit 205 performing an instruction retiring procedure finds an undefined instruction exception or a general-purpose exception, the exception handling unit 206 calls the undefined instruction exception handler or general-purpose exception handler registered in the interrupt descriptor table to cope with the undefined instruction exception or the general-purpose exception.

In an exemplary embodiment, the operating system integrates the scheduling of all cores. When the operating system starts to work, a ready queue shared by all cores is created by the operating system to store application processes those are in a ready state. To execute an application, the operating system creates a corresponding application process. When the application process meets its execution conditions (that is, the application process gains the required resources in addition to the processor), the operating system changes the application process to the ready state, and pushes the application process to the ready queue. When the operating system scheduler schedules the application process to run, the application process is changed to an execution state, and a processor core is selected to execute the application process. Referring to FIGS. 1 and 2, to execute an application process, the processor core reads instructions of the application process from the system memory 104, and stores them in the instruction cache 212. The decoder 214 decodes the instructions read from instruction cache 212, to generate microinstructions. After being renamed by the renaming unit 216, the microinstructions are sent to the reservation station (RS) 218 as well as the reorder buffer (ROB) 204 in their program order. The reorder buffer 204 writes the microinstructions received from the renaming unit 216 into a memory 207 in their program order. The microinstructions obtained from the reservation station 218 are executed by the instruction execution unit 220. According to the execution of microinstructions, the instruction execution unit 220 writes the execution results (including normal execution results and abnormal results) into the entries, corresponding to the microinstructions, in the memory 207. When the oldest microinstruction (according to the program order) in the memory 207 satisfies a retiring condition, the retiring unit 205 retires it (e.g., retiring the microinstructions 1 and 2 in the program order). If the target to be retired is related to an exception (e.g., the undefined instruction exception or the general-purpose exception), the processed instruction (target instruction) is sent to the exception handling unit 206.

Referring to FIGS. 2 and 5B, as requested by the retiring unit 205 to handle an exception, step S508 is performed. In step S508, the exception handling unit 206 checks the type of the exception caused by the first-type core 106_# executing the target instruction of a target application. If an undefined instruction exception #UD occurs due to the target instruction, the exception handling unit 206 calls the undefined instruction exception handler registered in the interrupt descriptor table to determine the opcode of the target instruction in step S510. If a general-purpose exception #GP occurs due to the target instruction, the exception handling unit 206 calls the general-purpose exception handler registered in the interrupt descriptor table to determine whether the target instruction is a special instruction in step S512.

In step S510, based on the opcode of the target instruction causing the undefined instruction exception #UD, the undefined instruction exception handler determines whether the target instruction is a special instruction defined in the disclosure. In an exemplary embodiment, the undefined instruction exception handler queries a special instruction table defined in the handler itself. If the opcode of the target instruction can be found in the special instruction table (hit), it is determined that the target instruction is a special instruction that should be executed by the second-type core 108_#, and the procedure proceeds to step S514. In step S514, the undefined instruction exception handler calls the operating system scheduler (or a schedule subsystem), to relate the current application to the second-type core 108_#, and schedules the second-type core 108_# to take over running the application. On the contrary, if step S510 cannot find the opcode of the target instruction in the special instruction table, the target instruction is not a special instruction, and the procedure proceeds to step S516 to deal with this exception in any traditional way. For example, the operating system displays a dialog box to remind the user that an undefined instruction was encountered during the execution of the application.

In step S512, the general-purpose exception handler determines whether the target instruction causing the general-purpose exception #GP is a special instruction defined in the disclosure. As mentioned above, in an exemplary embodiment, the general-purpose exception handler determines whether the target instruction is a special instruction based on the opcode of the target instruction and the error code of the general purpose protection exception #GP. In another exemplary embodiment, the general-purpose exception handler determines whether the target instruction is a special instruction based on the exception code of the general-purpose protected exception #GP. The specific method of determining whether the target instruction is a special instruction has been described previously, so it is not repeated here.

If step S512 determines that the target instruction is a special instruction, the procedure proceeds to step S514. The general-purpose exception handler calls the operating system scheduler to relate the current application to the second-type core 108_#, and schedules the second-type core 108_# to take over running the application. If step S512 determines that the target instruction is not a special instruction, the procedure proceeds to step S516 to deal with this exception in any traditional way. For example, the operating system deletes (kills) the application process causing the general-purpose exception #GP.

This paragraph introduces the details of step S514. According to the identification code obtained from the processor information structure (cpuinfo) of each core, the operating system scheduler sets an affinity field in the application process to show that the current application should be executed on the second-type core 108_#. Then, the operating system scheduler sends an Inter-Processor Interrupt (IPI for short, which is used as an inter-core interrupt in this disclosure) to the second-type core 108_#. In response to the received IPI, the second-type core 108 executes an IPI handler particularly designed for the proposed IPI. By executing the IPI handler, the operating system scheduler is awakened. According to the affinity field in the application process, the operating system scheduler schedules the application process to run on the second-type core 108_#. In an exemplary embodiment, if the second-type core 108_# is in sleep, the operating system needs to perform a wakeup procedure to wake up the second-type core 108_#. If the second-type core 108_# is already in a running state, the second-type core 108_# first finishes a part of the running application (for example, after finishing the current time slice assigned to the running application, or after the complete execution of current application). Then, the second-type core 108_# switches to execution of the target application. In an exemplary embodiment, the affinity field in the application process is designed in the process control block (PCB) of the application process.

Compared with step S514, other exception handlers used in step S516 will not migrate the application process to the second-type core 108_#.

In an exemplary embodiment, the operating system does not use the unified process scheduling as aforementioned. Instead, the operating system creates a separate ready queue for each core. Each core's ready queue only stores application processes that are in the ready state and are assigned to that core. Compared with an implementation of the unified process scheduling, the implementation separately scheduling the processes uses a different design in step S514 of FIG. 5B. According to the above-mentioned processor information structure (cpuinfo) of each core, the identification code of each core is obtained. Accordingly, the operating system scheduler selects a second-type core 108_# first, then pushes the application process into the ready queue of the selected second-type core 108_# and sends an IPI to the selected second-type core 108_#. In response to the received IPI, the second-type core 108_# reads its own ready queue to obtain and execute the target application.

The core change concept of this disclosure is further used to implement a method for application compatible execution. The method includes providing a hybrid architecture processor 102 that includes a first-type core 106_# and a second-type core 108_#, wherein the second-type core 108_# supports special instructions not supported by the first-type core 106_#, or supported by the first-type core 106_# in a semantically changed manner; and, in response to the first-type core 106_# executing an application that includes the special instructions, migrating the application to the second-type core 108_#.

There may be various modifications to the details of the aforementioned exemplary embodiments. Any hybrid architecture processor (including the first-type core 106_# and the second-type core 108_#) migrating an application from the first-type core 106_# to the second-type core 108_# based on the property of the application may fall into the scope of protection of the disclosure.

There are many options to implement the different types of cores. In an exemplary embodiment, a core with advanced and simplified hardware design is selected as the first-type core 106_#, while a core with general hardware design is selected as the second-type core 108_#. In another exemplary embodiment, using the same technology, a core with less hardware blocks is selected as the first-type core 106_# (also known as the small core), while a core with more hardware blocks is selected as the second-type core 108_# (also known as the big core). Alternatively, two cores with different supported instruction sets are regarded as the first-type core 106_# and the second-type core 108_#, separately.

Generally, the second-type core 108_# supports instructions not supported on the first-type core 106_#.

Through the computer system and application compatible execution method proposed in the disclosure, when the first-type core executes a special instruction not supported on the first-type core or supported on the first-type core in a semantically changed manner, the second-type core is scheduled to take over the execution of the application to fully utilize the resources of the second-type core.

While the disclosure has been described by way of example and in terms of the preferred embodiments, it should be understood that the disclosure is not limited to the disclosed embodiments.

What is claimed is:

1. A computer system, comprising:
a hybrid architecture processor, including a first-type core and a second-type core;
wherein:
the second-type core uses special instructions not supported by the first-type core, or supported by the first-type core in a semantically changed manner; and
in response to the first-type core executing an application that has any of the special instructions, the application is migrated to the second-type core for execution.

2. The computer system as claimed in claim 1, wherein:
in response to an undefined instruction exception, the first-type core runs a first exception handler;
the first exception handler determines whether a first target instruction causing the undefined instruction exception is one of the special instructions; and
in response to the first target instruction being one of the special instructions, the first exception handler calls an operating system scheduler to relate the application with the second-type core and schedule the second-type core to run the application.

3. The computer system as claimed in claim 2, wherein:
the first exception handler manages a special instruction table to list opcodes of the special instructions; and
in response to the undefined instruction exception, the first exception handler searches the special instruction table for an opcode of the first target instruction and, if the opcode of the first target instruction is listed in the special instruction table, the first exception handler determines that the first target instruction is one of the special instructions.

4. The computer system as claimed in claim 1, wherein:
in response to a general-purpose exception, the first-type core runs a second exception handler;
the second exception handler determines whether a second target instruction causing the general-purpose exception is one of the special instructions; and
in response to the second target instruction being one of the special instructions, the second exception handler calls an operating system scheduler to relate the application with the second-type core and schedule the second-type core to run the application.

5. The computer system as claimed in claim 4, wherein:
according to an exception code of the general-purpose exception, the second exception handler determines whether the second target instruction is one of the special instructions.

6. The computer system as claimed in claim 4, wherein:
according to an opcode of the second target instruction as well as an exception code of the general-purpose exception, the second exception handler determines whether the second target instruction is one of the special instructions.

7. The computer system as claimed in claim 1, further comprising:
a system memory; and
a basic input and output system, reading an identification code from each core for identification of the first-type core and the second-type core, and stores the identification code of each core in the system memory, to be read by an operating system later to form core information;
wherein:
the operating system generates an application process corresponding to the application; and
the operating system migrates the application process based on the core information, to switch to the second-type core to run the application.

8. The computer system as claimed in claim 7, wherein:
the basic input and output system creates an advanced configuration and power interface table for each core, and programs the identification code of each core into a flag field in the corresponding advanced configuration and power interface table; and
the basic input and output system programs the advanced configuration and power interface table of each core into the system memory, to be read by an operating system later to form the core information.

9. The computer system as claimed in claim 7, wherein:
the basic input and output system executes an acquiring identification code instruction on each core to obtain the identification code of each core.

10. The computer system as claimed in claim 7, wherein:
each core stores the identification code in a model-specific register to be read by the basic input and output system.

11. The computer system as claimed in claim 7, wherein:
when the operating system starts, the operating system registers a first exception handler and a second exception handler.

12. A method for application compatible execution, comprising:
providing a hybrid architecture processor that has a first-type core and a second-type core, wherein the second-type core uses special instructions not supported by the first-type core, or supported by the first-type core in a semantically changed manner; and
in response to the first-type core executing an application that has any of the special instructions, migrating the application to the second-type core for execution.

13. The method as claimed in claim 12, wherein:
in response to an undefined instruction exception, the first-type core runs a first exception handler;
the first exception handler determines whether a first target instruction causing the undefined instruction exception is one of the special instructions; and
in response to the first target instruction being one of the special instructions, the first exception handler calls an operating system scheduler to relate the application with the second-type core and schedule the second-type core to run the application.

14. The method as claimed in claim 13, wherein:
the first exception handler manages a special instruction table to list opcodes of the special instructions; and
in response to the undefined instruction exception, the first exception handler searches the special instruction table for an opcode of the first target instruction and, if the opcode of the first target instruction is listed in the special instruction table, the first exception handler determines that the first target instruction is one of the special instructions.

15. The method as claimed in claim 12, wherein:
in response to a general-purpose exception, the first-type core runs a second exception handler;
the second exception handler determines whether a second target instruction causing the general-purpose exception is one of the special instructions; and
in response to the second target instruction being one of the special instructions, the second exception handler calls an operating system scheduler to relate the application with the second-type core and schedule the second-type core to run the application.

16. The method as claimed in claim 15, wherein:
according to an exception code of the general-purpose exception, the second exception handler determines whether the second target instruction is one of the special instructions.

17. The method as claimed in claim 15, wherein:
according to an opcode of the second target instruction as well as an exception code of the general-purpose exception, the second exception handler determines whether the second target instruction is one of the special instructions.

18. The method as claimed in claim 12, further comprising:
operating a basic input and output system to read an identification code from each core for identification of the first-type core and the second-type core, and programming the identification code of each core into a system memory, to be read by an operating system later to form core information;
wherein:
the operating system generates an application process corresponding to the application; and
the operating system migrates the application process based on the core information, to switch to the second-type core to run the application.

19. The method as claimed in claim 18, wherein:
the basic input and output system creates an advanced configuration and power interface table for each core, and programs the identification code of each core into a flag field of the corresponding advanced configuration and power interface table; and
the basic input and output system programs the advanced configuration and power interface table of each core into the system memory, to be read by an operating system later to form the core information.

20. The method as claimed in claim 18, wherein:
the basic input and output system executes an acquiring identification code instruction on each core to obtain the identification code of each core.

21. The method as claimed in claim 18, wherein:
each core stores the identification code in a model-specific register to be read by the basic input and output system.

22. The method as claimed in claim 18, wherein:
when the operating system starts, the operating system registers a first exception handler and a second exception handler.
